(19) United States
(12) Patent Application Publication
(10) Pub. No.: US 2003/0202576 A1
(43) Pub. Date: Oct. 30, 2003

(54) Method and apparatus for decompressing and multiplexing multiple video streams in real-time

(75) Inventor: Michael A. Enright, Huntington Beach, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: The Boeing Company

(21) Appl. No.: 10/178,602

(22) Filed: Jun. 24, 2002

Related U.S. Application Data
(60) Provisional application No. 60/376,254, filed on Apr. 29, 2002.
(60) Provisional application No. 60/376,105, filed on Apr. 29, 2002.
(60) Provisional application No. 60/376,244, filed on Apr. 29, 2002.

(51) Int. Cl. H04N 7/12

(52) U.S. Cl. 375/240.01; 375/240.12

(57) ABSTRACT

One or more embodiments of the invention provide a method, apparatus, system, and/or article of manufacture for multiplexing and displaying a video stream in real-time. An original video stream and replacement video stream are received in real-time. Both video streams comprise encoded data that consist of one or more anchor frames (i.e., a frame that is not dependent on any other frame), and one or more predicted frames (i.e., a frame that is a computed difference between two video frames). One or more successive frames of the original video stream are output in real-time. A point in the original video stream where the replacement video stream is to be inserted is determined. Output is switched in real-time, to the replacement video stream when the point to insert has arrived. Thereafter, the output is returned in real-time, to the original video stream when the replacement video stream is complete.

### CROSS-REFERENCE TO RELATED APPLICATIONS

This application claims the benefit under 35 U.S.C. Section 119(e) of the following co-pending and commonly-assigned U.S. provisional patent application, which is incorporated by reference herein:

Provisional Application Serial No. 60/376,254, filed Apr. 29, 2002, by Michael A. Enright, entitled “METHOD TO DECOMPRESS AND MULTIPLEX MULTIPLE VIDEO STREAMS IN REAL-TIME,” attorneys' docket number 010581.

This application is related to the following co-pending and commonly-assigned patent applications, which applications are incorporated by reference herein:

Provisional Application Serial No. 60/376,105, filed Apr. 29, 2002, by Charles F. Stirling, Bernard M. Gudaitis, William G. Connelly and Catherine C. Girardey, entitled “SECURE DATA CONTENT DELIVERY SYSTEM FOR MULTIMEDIA APPLICATIONS UTILIZING BANDWIDTH EFFICIENT MODULATION,” attorneys' docket number PD-01-703; and

Provisional Application Serial No. 60/376,244, filed Apr. 29, 2002, by Ismael Rodriguez and James C. Campanella, entitled “A METHOD TO SECURELY DISTRIBUTE LARGE DIGITAL VIDEO/DATA FILES WITH OPTIMUM SECURITY,” attorneys' docket number 010892.

### BACKGROUND OF THE INVENTION

1. Field of the Invention

The present invention relates generally to displaying video streams, and in particular, to a method, apparatus, and article of manufacture for decompressing and multiplexing multiple video streams in real-time.

2. Description of the Related Art

With the proliferation, growth, and use of the Internet, mechanisms for high speed communication have become more easily available. Additionally, with the availability of high speed communication, sizeable content and data are distributed mote frequently. For example, the distribution of media programs (e.g., television programming, motion pictures, etc.) via satellite or other high bandwidth mediums have gained and continue to gain popularity.

However, while sizeable content may be more easily distributed via high bandwidth mediums, there is still a need to compress data to reduce the transmission time and/or the bandwidth consumed. Currently, video streams are compressed and encoded as a single entity. In order to display the video, it is decoded and decompressed as a single unit. Additionally, if mote than one video stream must be displayed, there can be a noticeable delay between when the first video stream ends and the next stream begins. Such delays are often unacceptable.

In addition to the above problems with distributing and displaying video streams, many limitations exist with respect to the video stream itself. For example, at this time, movies/media content is shown in their entirety and alternate endings are not allowed. Further, content within a movie (e.g., PG- or R-rated material) cannot be at different points within the movie. Instead, multiple copies of the entire movie must be created (i.e., a single entity/video stream must be utilized for the entire movie). For a movie with one of the two aforementioned endings, this means two (2) versions of the movie must be maintained. The maintaining of two versions in this manner is inefficient in terms of both storage and transmission.

The problems described above, may be better understood by describing video stream compression and decompression. As stated above, video data streams are decoded and decompressed as a single entity. For example, moving pictures expert group (MPEG) is a widely used standard for compressing video. MPEG uses intraframe coding (which exploits spatial characteristics) for individual frames but also uses interframe coding (which exploits temporal characteristics between different video frames). Interframe coding further compresses video data by encoding only the differences between periodic key frames. In this regard, key frames may be referred to as anchor frames or I-frames. Different types of compression may be utilized (e.g., MPEG-2, MPEG-4, MPEG-7, MPEG-21, or non-MPEG types of compression such as wavelet based or other proprietary schemes) to provide differing levels of resolution for the displayed video stream.

Accordingly, in most video compression algorithms (e.g., MPEG), high compression ratios are achieved in part by removing temporal redundancy (i.e., using interframe coding). Such removal is done by subtracting one part of the video frame from the next and encoding the difference. The difference calculation may be performed in nominally 8×8 or 16×16 pixel blocks. By computing the difference from one frame to the next and encoding the data, successive frames now become dependent on previous frames. Further, because of the dependency on previous frames, replacing an individual frame within the video sequence can cause sever degradation.

An example of frame dependency is illustrated in FIG. 1. FIG. 1 illustrates two (2) types of frames, anchor (or intra-frames) 102, which do not depend on previous frames, and predicted frames 104, which are dependent on previous frames.

There is therefore a need for a method and system for distributing, decompressing, and multiplexing multiple video streams in real-time such that content can be displayed in a seamless manner even though it may be contained within a number of independently compressed video streams.

### SUMMARY OF THE INVENTION

As described above, it is desirable to have the ability combine multiple video streams in real-time. One or more embodiments of the invention provide a method, apparatus, and article of manufacture for receiving, decompressing, multiplexing, and displaying multiple compressed video streams in real-time. An original video stream and replacement video stream are compressed for transmission across a transmission medium (e.g., satellite, cable, etc.). Such video streams contain one or more anchor frames (that are not dependent on any other frame) and one or more predicted frames (that are dependent on other frames).

The original video stream is decompressed and output to a display device. Once a point of insertion (i.e., of the replacement video stream) has arrived (e.g., as determined through the use of a look-up table), output is switched to the replacement video stream. Accordingly, the replacement stream is decompressed and output to a display device. Once the replacement stream has completed the desired amount, output is then returned to the original video stream. In this manner, the original video stream and replacement video stream are decompressed, multiplexed, and displayed.

### BRIEF DESCRIPTION OF THE DRAWINGS

Referring now to the drawings in which like reference numbers represent corresponding parts throughout:

FIG. 1 illustrates two (2) types of frames in a video stream in accordance with one or more embodiments of the invention;

FIGS. 2A and 2B depict a top-level functional block diagram of a media program distribution system used for distributing digital video streams in accordance with one or more embodiments of the invention;

FIG. 3 is a functional block diagram of a computer system that can be used in the decompressing, multiplexing, and displaying of multiple video streams in accordance with one or more embodiments of the invention;

FIG. 4 illustrates the use of anchor frames when a video sequence is modified in accordance with one or more embodiments of the invention;

FIG. 5 shows a system block diagram used to insert an updated video stream in real-time in accordance with one or more embodiments of the invention; and

FIG. 6 is a flow chart illustrating the decompressing, multiplexing, and displaying of a video stream in real-time in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

One or more embodiments of the invention provide the capability to decompress, multiplex, and display multiple video streams in real-time. A compressed original and compressed replacement video stream are both received. The original stream is decompressed and displayed in real-time. When a point to insert the replacement video stream (i.e., into the original video stream) has arrived, the replacement video stream is decompressed and output switches to the replacement video stream. When the replacement video stream is complete, output is then switched back to the original video stream. In this manner, the two video streams are decompressed, multiplexed together, and displayed in real-time.

Hardware Environment

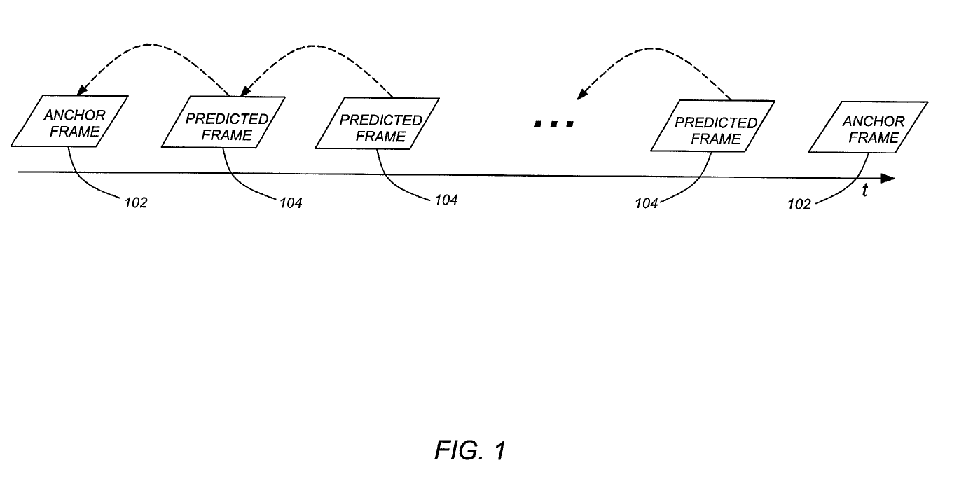

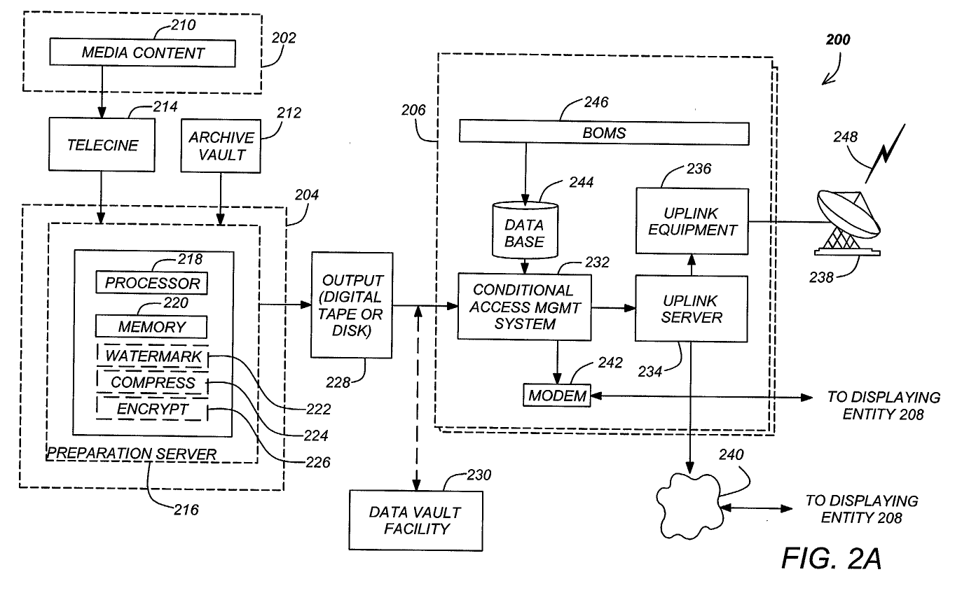

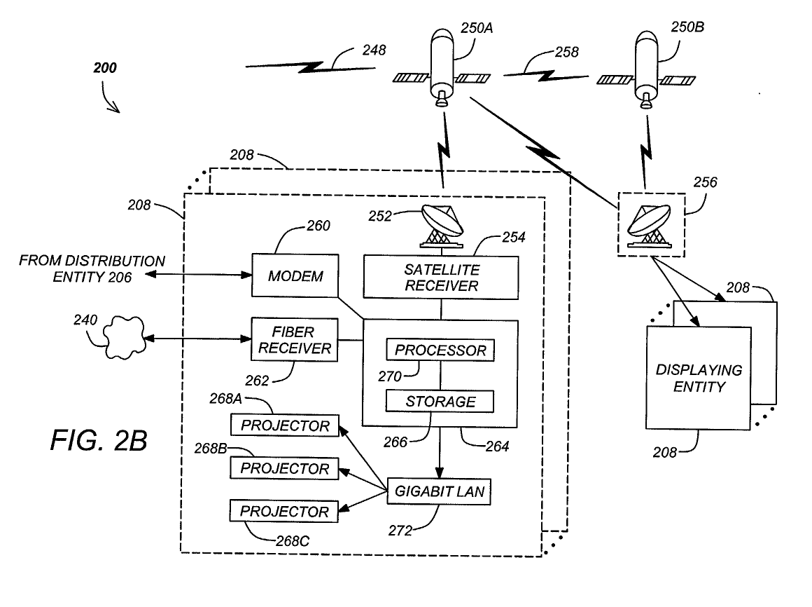

As described above, media content may be distributed in a variety of manners (e.g., via satellite, cable, radio frequency, etc.). FIGS. 2A and 2B depict a top-level functional block diagram of a media program distribution system (also referred to as a digital cinema system) 200 used for distributing digital video streams into theaters in accordance with one or mote embodiments of the invention. The media distribution system 200 comprises a content provider 202, a protection entity 204, a distribution entity 206 and one or more presentation/displaying entities 208. The content provider 202 provides media content 210 such as audiovisual material (e.g., the video stream described above and illustrated in FIG. 1) to the protection entity 204. The media content 210, which can be in digital or analog form, can be transmitted in electronic form via the Internet, by dedicated land line, broadcast, or by physical delivery of a physical embodiment of the media (e.g. a celluloid film strip, optical or magnetic disk/tape). Content can also be provided to the protection entity 204 (also referred to as a preparation entity) from a secure archive facility 212.

The media content 210 may be telecined by processor 214 to format the media program as desired. The telecine process can take place at the content provider 202, the protection entity 204, or a third party.

The protection entity 204 may include a media preparation processor 216. In one embodiment, the media preparation processor 116 includes a computer system such as a server, having a processor 218 and a memory 220 communicatively coupled thereto. The protection entity 204 further prepares the media content 210. Such preparation may include adding protection to the media content 210 to prevent piracy of the media content 210. For example, the preparation processor 216 can add watermarking 222 and/or encrypt 226 the media content 210 to protect it. In addition, the preparation processor can also apply compression 224 to the media content 210. Once prepared, the output media content 228 can be transferred to digital tape or a disk (e.g. a DVD, laserdisk, or similar medium). The output media content 228 can then be archived in a data vault facility 230 until it is needed.

When needed, the prepared output media content 228 is then provided to the distribution entity 206 (alternatively referred to hereinafter as the network operations center [NOC]). Although illustrated as separate entities, the protection entity 204 and the distribution entity 206 can be combined into a single entity, thus ameliorating some security concerns regarding the transmission of the output media content 228.

The distribution entity 206 includes a conditional access management system (CAMS) 232 (also referred to as a configuration management engine), that accepts the output media content 228, and determines whether access permissions are appropriate for the content 228. Further, CAMS 232 may be responsible for additional encrypting so that unauthorized access during transmission is prevented. Once the data is in the appropriate format and access permissions have been validated, CAMS 232 provides the output media content 228 to an uplink server 234, ultimately for transmission by uplink equipment 236 to one or more displaying entities 208 (also referred to as exhibitor systems) (shown in FIG. 2B). This is accomplished by the uplink equipment 236 and uplink antenna 238. Also, as shown, in addition or in the alternative to transmission via satellite, the media program can be provided to the displaying entity 208 via a forward channel fiber network 240. Additionally, information may be transmitted to displaying entity 208 via a modem 242 using, for example a public switched telephone network line. A land based communication such as through fiber network 240 or modem 242 is referred to as a back channel. Thus, information can be transmitted to and from the displaying entity 208 via the back channel or the satellite network. Typically, the back channel provides data communication for administration functions (e.g. billing, authorization, usage tracking, etc.), while the satellite network provides for transfer of the output media content 228 to the displaying entities 208.

The output media content 228 may be securely stored in a database 244. Data is transferred to and from the database 244 under the control and management of the business operations management system (BOMS) 246. Thus, the BOMS 246 manages the transmission of information to 208, and assures that unauthorized transmissions do not take place.

Turning to FIG. 2B, the data transmitted via uplink 248 is received in a satellite 250A, and transmitted to a downlink antenna 252, which is communicatively coupled to a satellite or downlink receiver 254.

In one embodiment, the satellite 250A also transmits the data to an alternate distribution entity 256 and/or to another satellite 250B via crosslnk 258. Typically, satellite 250B services a different terrestrial region than satellite 250A, and transmits data to displaying entities 208 in other geographical locations.

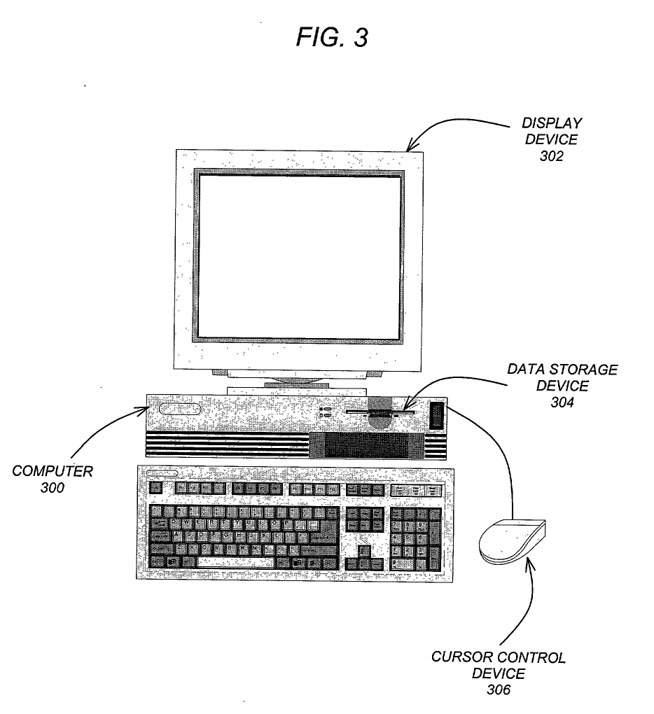

A typical displaying entity 208 comprises a modem 260 (and may also include a fiber receiver 258) for receiving and transmitting information through the back channel (i.e., via a communication path other than that provided by the satellite system described above) to and from the distribution entity 206. For example, feedback information (e.g. relating to system diagnostics, billing, usage and other administrative functions) from the exhibitor 208 can be transmitted through the back channel to the distribution entity 206. The output media content 228 and other information may be accepted into a processing system 264 (also referred to as a content server) such as a server or computer similar to that which is illustrated in FIG. 3 (see description below). The output media content 228 may then be stored in the storage device 266 for later transmission to displaying systems (e.g., digital projectors) 268A-268C. Before storage, the output media content 228 can be decrypted to remove transmission encryption (e.g. any encryption applied by the CAMS 232), leaving the encryption applied by the preparation processor 216.

When the media content 210 is to be displayed, final decryption techniques are used on the output media content 228 to substantially reproduce the original media content 210 in a viewable form which is provided to one or more of the displaying systems 268A-268C. For example, encryption 226 and compression 224 applied by the preparation processor 218 is finally removed, however, any latent modification, undetectable to viewers (e.g., watermarking 222) is left intact. In one or more embodiments, a display processor 270 prevents storage of the decrypted media content in any media, whether in the storage device 266 or otherwise. In addition, the media content 210 can be communicated to the displaying systems 268A-268C over an independently encrypted connection, such as on a gigabit LAN 272.

FIG. 3 is a functional block diagram of a computer system 300 that can be used to perform the operations of the media preparation processor 216 and processing system 264. Embodiments of the invention are typically implemented using a computer 300, which generally includes, inter alia, a display device 302, data storage devices 304, cursor control devices 306, and other devices. Those skilled in the art will recognize that any combination of the above components, or any number of different components, peripherals, and other devices, may be used with the computer 300.

Programs executing on the computer 300 (such as an operating system) are comprised of instructions which, when read and executed by the computer 300, causes the computer 300 to perform the steps necessary to implement and/or use the present invention. Computer programs and/or operating instructions may also be tangibly embodied in a memory and/or data communications devices of the computer, thereby making a computer program product or article of manufacture according to the invention. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present invention. For example, those skilled in the art will recognize that any combination of the above components, or any number of different components, peripherals, and other devices, may be used with the present invention.

Video Stream Insertion/Replacement

As described above, the media distribution system 200 can be used to distribute media content such as video streams for display in theaters or displaying entities 208. In addition to the media distribution system 200, video streams may be distributed in any other manner, such as via cable and/or satellite to set-top boxes for home viewing. In yet another alternative, multiple video streams may be stored on a digital video disc (DVD) for display using a DVD player on a television or other display device.

However, the problems (as described above) associated with viewing a video stream regardless of the mechanism and/or manner of distribution may still remain. As stated above, video data streams are decoded and decompressed as a single entity.

In most video compression algorithms, high compression ratios are achieved in part by removing temporal redundancy (e.g. MPEG encoding) wherein the differences between frames are encoded such that successive frames become dependent on previous frames (i.e., as illustrated in FIG. 1). Because of the dependency on previous frames, replacing an individual frame within the video sequence can cause severe degradation. As shown in FIG. 1, predicted frames may only be dependent on previous frames. However, the predicted frames may be dependent on previous or future frames as defined by the compression algorithm. Additionally, predicted frames may be dependent on multiple previous/future (or a combination of both) frames.

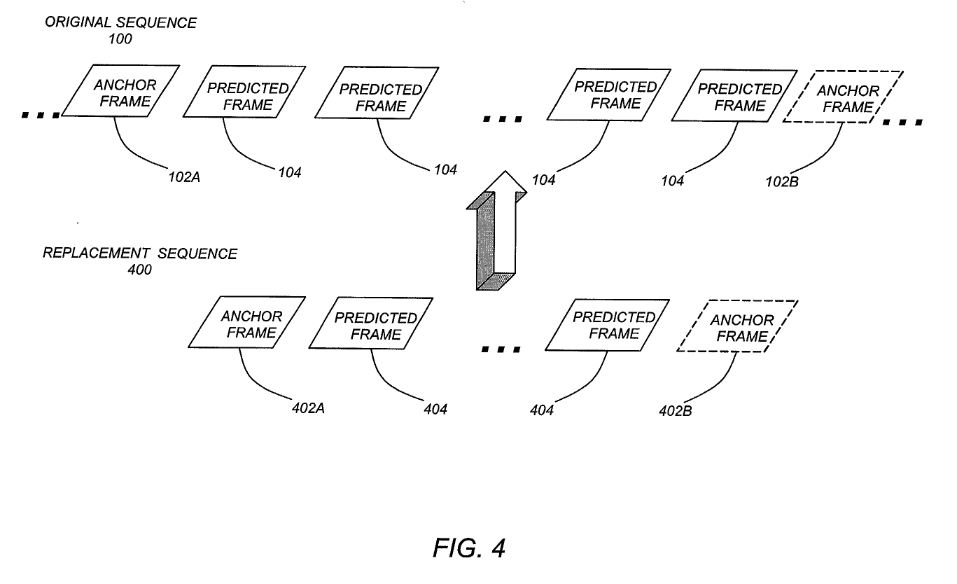

Because of frame inter-dependency, anchor frames may be required to be inserted whenever the video sequence is modified. FIG. 4 illustrates the use of anchor frames when a video sequence is modified (e.g., when a replacement video stream is inserted into an original stream). The original video sequence 100 is shown along with the replacement sequence 400. For the original video sequence 100, the last frame 102A of the video sequence 100 prior to the first inserted frame 402A and the first frame 102B of the video sequence 100 following the last inserted frame 402B must be anchor frames 102. However, it should be noted that if predicted frames 104 are only dependent on previous frames and not future frames, the first frame 102B following the last inserted frame 402B does not need to be an anchor frame 102. Similarly, if predicted frames 104 are not dependent on previous frames, but only on future frames, then frame 102A need not be an anchor frame 102 and only frame 102B must be an anchor frame 102.

In addition, for the replacement video stream 400, its first 402A and last 402B frames must also be anchor frames 102. However, similar to the original sequence 100, if predicted frames 404 are only dependent on previous frames and not future frames, then the last frame 402B does not need to be an anchor frame 402. Similarly, if predicted frames 404 are only dependent on future frames (and not previous frames), the first frame 402A need not be an anchor frame 402.

Based on the above-described use of anchor frames 102 and 402, at the boundaries of the replacement video sequence 400, there will exist back to back anchor frames (102A and 402A, and 102B and 402B). Thus, any predicted frame 104 and 404, albeit forward or backward, must not refer to a frame in the replacement sequence 400. Likewise, any frame within a replacement sequence 400 must not refer to a frame outside of its boundaries.

Real-Time Video Stream Insertion

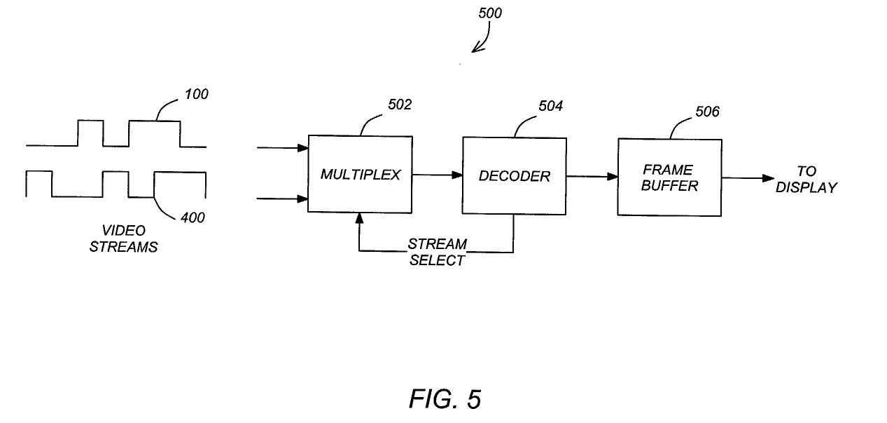

A method for inserting the updated video 400 into the stream 100 is described above. One or more embodiments of the invention provide the ability to insert the updated video 400 in real-time. FIG. 5 shows a system block diagram used to insert the updated video stream 400 in real-time. The system 500 is comprised of a multiplexor 502, decoder 504, and frame buffer 506. The multiplexor 502 is used to select which bit stream 100 or 400 to use under control of the decoder 504. The multiplexor 502 may get its inputs from a specified set of files. As described above, the video stream 100/400 may be contained within the same file or they may be separated into individual files. The file selection is under control of the decoder 504. Once the decoder 504 determines that a point of insertion (i.e., in an original video stream 100) has arrived, it switches to the other video stream 400 as specified above.

The decoder 504 may determine when to insert a replacement set of frames 400 via a lookup table. In this way, the decoder 504 or its control processor will have a mapping of frame number to associated file or video stream 100/400. When a replacement video stream 400 is completed, the decoder 504 returns to the original video stream 100.

On return to the original stream 100, the decoder 504 must now choose the correct frame to display next. A variety of methods may be utilized to make the determination regarding the appropriate frame to return to. For example, the decoder 504 may examine the last frame number. In one or more embodiments, the inserted video stream 400 contains the same number of frames that it is replacing. Accordingly, the last frame number of the inserted stream 400 is incremented by one (1) to indicate the next frame number that must be shown from the original stream 100. Hence, the decoder 504 must search forward in the original stream 100 until it finds this frame number. At that point, the decoder 504 begins its playback from the original stream 100. Further, as described above, if the last frame (i.e., frame 102B) is an anchor frame 102, there may be no dependence on the previous frame.

As an alternative to or in addition to incrementing the frame count by one (1), the lookup table may contain an additional column that contains the frame number/location in the original stream 100 where playback should return to. In such an embodiment, the decoder 504 merely looks up the location and searches the original stream 100 for the appropriate location. In yet another embodiment, metadata or other information is encoded in the video stream 100 such that the frame where playback commences is identifiable. In such an embodiment, frame numbers may not be relevant and the decoder 504 merely needs to search or locate the appropriate identifier.

The frame buffer 506 is used to account for differences in data processing requirements. For example, if a predicted frame 104/404 is dependent on multiple frames, the frame buffer 506 may be used to process the multiple dependencies to display the predicted frame 104/404.

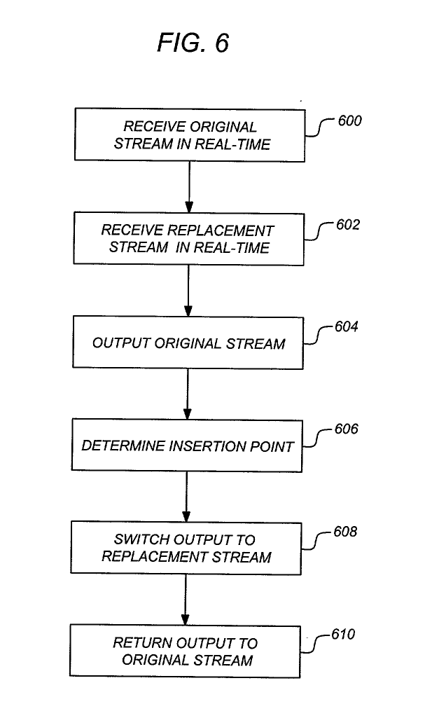

FIG. 6 is a flow chart illustrating the decompressing, multiplexing, and displaying of a video stream in real-time in accordance with one or more embodiments of the invention. At step 600, an original video stream 100 is received in real-time. As described above, the original video stream 100 comprises encoded data including one or more anchor frames and one or more predicted frames.

At step 602 a replacement video stream 400 is received in real-time. Similar to the original video stream 100, the replacement video stream 400 contains encoded data that includes one or more anchor frames and one or more predicted frames. At step 604, one or more successive frames of the original video stream 100 are output in real-time.

At step 606, a point in the original video stream 100 where the replacement stream 400 is to be inserted is determined (e.g., by a decoder 504). As described above such a determination may include the use of a look-up table that contains a mapping of a frame number to an associated file or video stream.

At step 608, output is switched (e.g., through the multiplexor 502), in real-time, from the original video stream 100, to the replacement video stream 400 when the insertion point has arrived. When the replacement video stream is complete, output is returned, in real-time, from the replacement video stream 400, back to the original video stream 100 at step 610.

Conclusion

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention. In summary, embodiments of the invention provide a method, apparatus, system, and/or article of manufacture for decompressing and multiplexing multiple video streams in real-time.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for displaying a video stream in real-time comprising:
(a) receiving an original video stream in real-time, wherein the original video stream comprises encoded data, wherein the encoded data comprises:
(i) one or more anchor frames, wherein each anchor frame is not dependent on any other frame; and
(ii) one or more predicted frames, wherein each predicted frame comprises a computed difference between a first video frame and a second video frame such that the predicted frame is dependent on the first video frame;
(b) receiving a replacement video stream in real-time, wherein the replacement video stream comprises encoded data that comprises:
(i) one or more anchor frames; and
(ii) one or more predicted frames;
(c) outputting one or more successive frames of the original video stream in real-time;
(d) determining a point in the original video stream to insert the replacement video stream;
(e) switching output, in real-time, to the replacement video stream when the point to insert has arrived; and
(f) returning output, in real-time, to the original video stream when the replacement video stream is complete.

2. The method of claim 1, wherein the first video frame is an anchor frame.

3. The method of claim 1, wherein the first video frame is a predicted frame.

4. The method of claim 1, wherein an anchor frame is inserted whenever the original video stream is modified.

5. The method of claim 1, wherein one anchor frame comprises a last frame of the original video stream prior to a first inserted frame of the replacement video stream.

6. The method of claim 1, wherein one anchor frame comprises a first frame of the original video stream following a last inserted frame of the replacement video stream.

7. The method of claim 1, wherein a first frame of the replacement video stream is an anchor frame.

8. The method of claim 1, wherein a last frame of the replacement video stream is an anchor frame.

9. The method of claim 1, wherein a lookup table is used to determine when to insert the replacement video stream.

10. The method of claim 9, wherein the lookup table comprises a mapping of a frame number to an associated file or video stream.

11. The method of claim 1, wherein a decoder determines when to insert the replacement video stream.

12. The method of claim 1, wherein a multiplexor is used to select which video stream to use.

13. The method of claim 1, wherein returning output to the original video stream comprises:
determining a last frame number of the replacement video stream;
searching forward in the original video stream until a frame number in the original video stream is found that is based on the last frame number; and
outputting the original video stream beginning with the found frame number.

14. The method of claim 1, wherein a frame buffer is used to account for differences in processing requirements between the original video stream and the replacement video stream.

15. A system for displaying a video stream in real-time comprising:
(a) an original video stream comprising encoded data, wherein the encoded data comprises:
(i) one or more anchor frames, wherein each anchor frame is not dependent on any other frame; and
(ii) one or more predicted frames, wherein each predicted frame comprises a computed difference between a first video frame and a second video frame such that the predicted frame is dependent on the first video frame;
(b) a replacement video stream, wherein the replacement video stream comprises encoded data that comprises:
(i) one or more anchor frames; and
(ii) one or more predicted frames;
(c) a multiplexor configured to:
(i) receive the original video stream and replacement video stream in real-time; and
(ii) output the original video stream or the replacement video stream in real-time; and
(d) a decoder configured to control the output of the multiplexor in real-time by:
(i) selecting the original video stream to be output by the multiplexor;
(ii) determining when a point in the original video stream has arrived, wherein the point indicates when to insert the replacement video stream;
(iii) selecting the replacement video stream to be output by the multiplexor when the point to insert has arrived; and
(iv) returning output of the multiplexor to the original video stream when the replacement video stream is complete.

16. The system of claim 15, wherein the first video frame is an anchor frame.

17. The system of claim 15, wherein the first video frame is a predicted frame.

18. The system of claim 15, wherein an anchor frame is inserted whenever the original video stream is modified.

19. The system of claim 15, wherein one anchor frame comprises a last frame of the original video stream prior to a last inserted frame of the replacement video stream.

20. The system of claim 15, wherein one anchor frame comprises a first frame of the original video stream following a last inserted frame of the replacement video stream.

21. The system of claim 15, wherein a first frame of the replacement video stream is an anchor frame.

22. The system of claim 15, wherein a last frame of the replacement video stream is an anchor frame.

23. The system of claim 15, wherein the decoder is configured to utilize a lookup table to determine when to select the replacement video stream.

24. The system of claim 23, wherein the lookup table comprises a mapping of a frame number to an associated file or video stream.

25. The system of claim 15, wherein the decoder is configured to return output to the original video stream by:
determining a last frame number of the replacement video stream;
searching forward in the original video stream until a frame number in the original video stream is found that is based on the last frame number; and
outputting the original video stream beginning with the found frame number.

26. The system of claim 15, further comprising a frame buffer that is configured to account for differences in processing requirements between the original video stream and the replacement video stream.
